(19) United States
(12) Patent Application Publication
(10) Pub. No.: US 2018/0020397 A1
(43) Pub. Date: Jan. 18, 2018

(54) APPARATUS AND METHOD FOR PROXIMITY-BASED SERVICE COMMUNICATION

(71) Applicant: NEC Corporation, Minato-ku, Tokyo (JP)

(72) Inventors: Hiroaki AMINAKA, Tokyo (JP); Hiroto SUGAHARA, Tokyo (JP)

(73) Assignee: NEC Corporation, Minato-ku, Tokyo (JP)

(21) Appl. No.: 15/545,777

(22) PCT Filed: Nov. 5, 2015
(86) PCT No.: PCT/JP2015/005539

§ 371 Date: Jul. 24, 2017

(30) Foreign Application Priority Data
Feb. 6, 2015 (JP) 2015-022415

(51) Int. Cl. H04W 48/16; H04W 48/18; H04W 8/18

(52) U.S. Cl. CPC H04W 48/16; H04W 8/183; H04W 48/18

(57) ABSTRACT

A radio terminal (1) updates a preconfigured radio parameter (409, 814) stored in a memory (406, 810) coupled to the radio terminal (1). The preconfigured radio parameter (409, 814) is used by the radio terminal (1) to perform at least one of discovery and direct communication without the assistance of a Public Land Mobile Network (100). This contributes, for example, to flexible adaptation to conditions under which the ProSe communication without the assistance of a network is performed.

### TECHNICAL FIELD

The present Application relates to Proximity-based services (ProSe) and, more particularly, to Prose communications without the assistance of a network.

### BACKGROUND ART

3GPP Release 12 specifies proximity-based services (ProSe) (see, for example, Non-Patent Literature 1). ProSe includes ProSe Discovery and ProSe Direct Communication. ProSe Discovery enables detecting proximity of radio terminals. ProSe Discovery includes direct discovery (ProSe Direct Discovery) and network-level discovery (EPC-level ProSe Discovery).

ProSe Direct Discovery is performed through a procedure in which a ProSe-enabled UE detects another ProSe-enabled UE by using only capability of a radio communication technology (e.g., Evolved Universal Terrestrial Radio Access (E-UTRA) technology) possessed by these two UEs. On the other hand, in EPC-level ProSe Discovery, a core network (i.e., Evolved Packet Core (EPC)) determines proximity of two ProSe-enabled UEs, and notifies these UEs of detection of proximity. ProSe Discovery may be performed by three or more ProSe-enabled UEs.

ProSe Direct Communication enables, after the ProSe Discovery procedure, two or more ProSe-enabled UEs existing in the direct communication range to establish a communication path between them. In other words, ProSe Direct Communication enables a ProSe-enabled UE to directly communicate with another ProSe-enabled UE, without communicating through a public land mobile network (PLMN) including a base station (an eNodeB). ProSe Direct Communication may be performed by using a radio communication technology that is also used to access a base station (eNodeB) (i.e., E-UTRA technology) or by using a wireless local area network (WLAN) radio technology (i.e., IEEE 802.11 radio technology).

According to 3GPP Release 12, a ProSe function communicates with a ProSe-enabled UE via a public land mobile network (PLMN), to assist in ProSe Discovery and ProSe Direct Communication. The ProSe function is a logical function that is used for PLMN-related operations that are necessary for ProSe in performing network-assisted ProSe. The functionality provided by the ProSe function includes, for example: (a) communication with third-party applications (a ProSe Application Server); (b) authentication of a UE for ProSe Discovery and ProSe Direct Communication; (c) transmission of configuration information to a UE for ProSe Discovery and ProSe Direct Communication (e.g., an EPC-ProSe-User ID); and (d) provision of the network-level discovery (i.e., EPC-level ProSe Discovery). The ProSe function may be implemented on a single or a plurality of network node(s) or entity (entities). In the present specification, a single or a plurality of network node(s) on which the ProSe function is implemented is/are referred to as the “ProSe function entity (entities)” or the “ProSe function server(s)”.

As described above, in 3GPP Release 12 ProSe, a PLMN (e.g., the ProSe function and the eNodeB) assists ProSe-enabled UEs in ProSe Discovery and ProSe Direct Communication. However, mainly for public safety reasons, it has also been considered to make one or both of ProSe Direct Discovery and ProSe Direct Communication available to ProSe-enabled UEs without the assistance of a PLMN when the ProSe-enabled UEs cannot connect to the PLMN, such as when the ProSe-enabled UEs are out of the coverage of the PLMN. Non-Patent Literature 2 proposes storing, in a Universal Integrated Circuit Card (UICC), pre-configuration containing radio parameters that are necessary for performing non-PLMN-assisted ProSe without the assistance of a PLMN (hereinafter referred to as “non-PLMN-assisted ProSe”). According to the pre-configuration stored in the UICC, ProSe-enabled UEs can perform one or both of non-PLMN-assisted ProSe Direct Discovery and non-PLMN-assisted ProSe Direct Communication.

Note that, 3GPP Release 12 ProSe is one example of proximity-based services (ProSe) which are provided based on geographic proximity of a plurality of radio terminals. The proximity-based services in a public land mobile network (PLMN) include, similarly to 3GPP Release 12 ProSe, discovery and direct-communication phases assisted by a function or a node (e.g., the ProSe function) located in the network. In the discovery phase, geographic proximity of radio terminals is determined or detected. In the direct communication phase, the radio terminals perform direct communication. The direct communication is performed between radio terminals in proximity to each other, without communicating through a public land mobile network (PLMN). The direct communication is also referred to as “device-to-device (D2D) communication” or “peer-to-peer communication”. In the present specification, the term “ProSe” is not limited to 3GPP Release 12 ProSe, and refers to proximity-based service communication including at least one of discovery and direct communication. Further, the terms “proximity-based service communication” and “ProSe communication” used in the present specification each refer to at least one of the discovery and the direct communication.

The term public land mobile network (PLMN) used in the present specification refers to a wide-area radio infrastructure network, and a multiple access mobile communication system. The multiple access-scheme mobile communication system allows a plurality of mobile terminals to share a radio resource including at least one of time, frequencies, and transmission power, thereby enabling the plurality of mobile terminals to wirelessly communicate with each other substantially simultaneously. Typical examples of multiple access schemes include Time Division Multiple Access (TDMA), Frequency Division Multiple Access (FDMA), Code Division Multiple Access (CDMA), Orthogonal Frequency Division Multiple Access (OFDMA), and any combination thereof. The public land mobile network includes a radio access network and a core network. The public land mobile network is, for example, a 3GPP Universal Mobile Telecommunications System (UMTS), a 3GPP Evolved Packet System (EPS), a 3GPP 2 CDMA2000 system, a Global System for Mobile communications (GSM (registered trademark))/General packet radio service (GPRS) system, a WiMAX system, or a Mobile WiMAX system. The EPS includes a Long Term Evolution (LTE) system and an LTE-Advanced system.

The UICC is a smart card used in a cellular communication system such as a Global System for Mobile Communications (GSM) system, a Universal Mobile Telecommunications System (UMTS), and a Long Term Evolution (LTE) system. The UICC includes a processor and a memory, and executes a Subscriber Identity Module (SIM) application or Universal Subscriber Identity Module (USIM) application for network authentication. The UICC stores, in its memory, credentials necessary for accessing a PLMN, executes the SIM application or the USIM application and controls authentication of a UE. The credentials include, for example, an International Mobile Subscriber Identity (IMSI). The credentials may also be referred to as identity information or a SIM profile. Further, the UICC can store and execute various applications other than the SIM application and the USIM application. In a strict sense, the UICC is different from the UIM, the SIM, and the USIM. However, these terms are often used synonymously. Accordingly, while the present application mainly employs the term UICC, the term UICC as used herein may also refer to the UIM, the SIM, the USIM or the like.

### CITATION LIST

### Non Patent Literature

Non-Patent Literature 1: 3GPP TS 23.303 V12.3.0 (2014-12), “3rd Generation Partnership Project; Technical Specification Group Services and System Aspects; Proximity-based services (ProSe); Stage 2 (Release 12)”, December 2014
Non-Patent Literature 2: 3GPP R2-145379, Qualcomm Incorporated, “Offline Discussion report: Parameters for pre-configuration”, November 2014

### SUMMARY OF INVENTION

### Technical Problem

Assuming, for example, that a communication infrastructure becomes unavailable due to a major disaster (e.g., fire, earthquake, or tsunami), multiple UE groups may need to perform ProSe communication in an identical area. These UE groups include, for example, a UE group used by firefighters, a UE group used by rescue crews, a UE group used by municipal employees, a UE group used by volunteers, and a UE group used by ordinary citizens. It is preferable that these UE groups can perform non-PLMN-assisted ProSe communication independently of one another. However, it may be inefficient to finely divide radio resources and allocate in advance each divided radio resource to a respective one of the UE groups. For example, when the number of UE groups existing in proximity to one another in an identical area is small, preferably each UE group can use a relatively larger amount of unused radio resources. Conversely, when the number of UE groups existing in proximity to one another in an identical area is large, preferably the radio resources are finely divided so as to avoid interference among the UE groups.

As has already been described, the pre-configuration for non-PLMN-assisted ProSe communication (i.e., preconfigured radio parameters) is stored in, for example, the UICC. However, dynamic updating of the pre-configuration is not considered. Thus, the pre-configuration may not be capable of flexibly adapting to conditions under which non-PLMN-assisted ProSe communication is performed (e.g., the number of UE groups existing in proximity to one another). Accordingly, one object of embodiments disclosed in the present specification is to provide an apparatus, a method, and a program that contribute to flexible adaptation to conditions under which non-PLMN-assisted ProSe communication is performed.

### Solution to Problem

In a first aspect, a radio terminal includes at least one radio transceiver, at least one processor, a protocol module, and an updating module. The at least one radio transceiver includes a radio transceiver for communicating with a Public Land Mobile Network (PLMN). The at least one processor is coupled to the at least one radio transceiver. The protocol module includes a software module to be executed by the at least one processor and is configured to perform, using the at least one radio transceiver, at least one of PLMN-assisted discovery and PLMN-assisted direct communication within a coverage of the PLMN. The protocol module is further configured to perform, using the at least one radio transceiver, at least one of non-PLMN-assisted discovery and non-PLMN-assisted direct communication according to a preconfigured radio parameter. The updating module is configured to update the preconfigured radio parameter stored in a memory coupled to the radio terminal.

In a second aspect, a UICC configured to be coupled to a radio terminal includes a processor, a memory area, and a software module. The memory area is configured to store a preconfigured radio parameter used by the radio terminal to perform at least one of non-Public Land Mobile Network (PLMN)-assisted discovery and non-PLMN-assisted direct communication. The software module is executed by the processor to update the preconfigured radio parameter stored in the memory area.

In a third aspect, a server apparatus includes a memory and at least one processor coupled to the memory. The at least one processor is configured to communicate, via a network, with a radio terminal or a Universal Integrated Circuit Card (UICC) coupled to the radio terminal, and request the radio terminal or the UICC to update a preconfigured radio parameter. The preconfigured parameter is stored in the radio terminal or the UICC. Furthermore, the preconfigured parameter is used by the radio terminal to perform at least one of non-Public Land Mobile Network (PLMN)-assisted discovery and non-PLMN-assisted direct communication.

In a fourth aspect, a method performed in a radio terminal includes updating a preconfigured radio parameter stored in a memory coupled to the radio terminal. The preconfigured radio parameter is used by the radio terminal to perform at least one of non-Public Land Mobile Network (PLMN)-assisted discovery and non-PLMN-assisted direct communication.

In a fifth aspect, a method performed in a Universal Integrated Circuit Card (UICC) configured to be coupled to a radio terminal includes executing a software module on the UICC to update a preconfigured radio parameter stored in a memory area within the UICC. The preconfigured radio parameter is used by the radio terminal to perform at least one of non-Public Land Mobile Network (PLMN)-assisted discovery and non-PLMN-assisted direct communication.

In a sixth aspect, a method performed in a remote management server includes communicating, via a network, with a radio terminal or a Universal Integrated Circuit Card (UICC) coupled to the radio terminal to request the radio terminal or the UICC to update a preconfigured radio parameter. The preconfigured parameter is stored in the radio terminal or the UICC. Furthermore, the preconfigured parameter is used by the radio terminal to perform at least one of non-Public Land Mobile Network (PLMN)-assisted discovery and non-PLMN-assisted direct communication.

In a seventh aspect, a program includes a set of instructions (software codes) that, when loaded into a computer, causes the computer to perform the method according to the above-described fourth, fifth, or sixth aspect.

### Advantageous Effects of Invention

According to the aforementioned aspects, it is possible to provide an apparatus, a method, and a program that contribute to flexible adaptation to conditions under which non-PLMN-assisted ProSe communication is performed.

### BRIEF DESCRIPTION OF DRAWINGS

FIG. 1 is a diagram showing a configuration example of radio communication systems according to some embodiments;

FIG. 2 is a diagram showing a configuration example of radio communication systems according to some embodiments;

FIG. 3 is a diagram showing a configuration example of a radio communication system according to some embodiments;

FIG. 4 is a block diagram showing a configuration example of a UE according to a first embodiment;

FIG. 5 is a flowchart showing an example of a procedure for performing ProSe communication according to the first embodiment;

FIG. 6 is a flowchart showing an example of a procedure for updating a ProSe preconfigured parameter according to the first embodiment;

FIG. 7 is a diagram showing a concept of updating of the ProSe preconfigured parameter based on communication between a UE and a remote management server according to the first embodiment;

FIG. 8 is a block diagram showing a configuration example of a UE according to a second embodiment;

FIG. 9 is a flowchart showing an example of a procedure for updating a ProSe preconfigured parameter according to the second embodiment;

FIG. 10 is a block diagram showing a configuration example of a UE according to a third embodiment;

FIG. 11 is a flowchart showing an example of a procedure for updating a ProSe preconfigured parameter according to the third embodiment;

FIG. 12 is a block diagram showing a configuration example of a UE according to a fourth embodiment;

FIG. 13 is a flowchart showing an example of a procedure for updating a ProSe preconfigured parameter according to the fourth embodiment;

FIG. 14 is a diagram showing a configuration example of a network according to a fifth embodiment;

FIG. 15 is a flowchart showing an example of a procedure for updating a ProSe preconfigured parameter according to the fifth embodiment; and

FIG. 16 is a block diagram showing a configuration example of a remote management server.

### DESCRIPTION OF EMBODIMENTS

Specific embodiments are explained hereinafter in detail with reference to the drawings. The same or corresponding elements are denoted by the same symbols throughout the drawings, and duplicated explanations are omitted as necessary for the sake of clarity.

Embodiments described below will be explained mainly using specific examples with regard to an Evolved Packet System (EPS). However, these embodiments are not limited to being applied to the EPS and may also be applied to other mobile communication networks or systems such as a 3GPP UMTS, a 3GPP 2 CDMA2000 system, a GSM/GPRS system, and a WiMAX system.

### First Embodiment

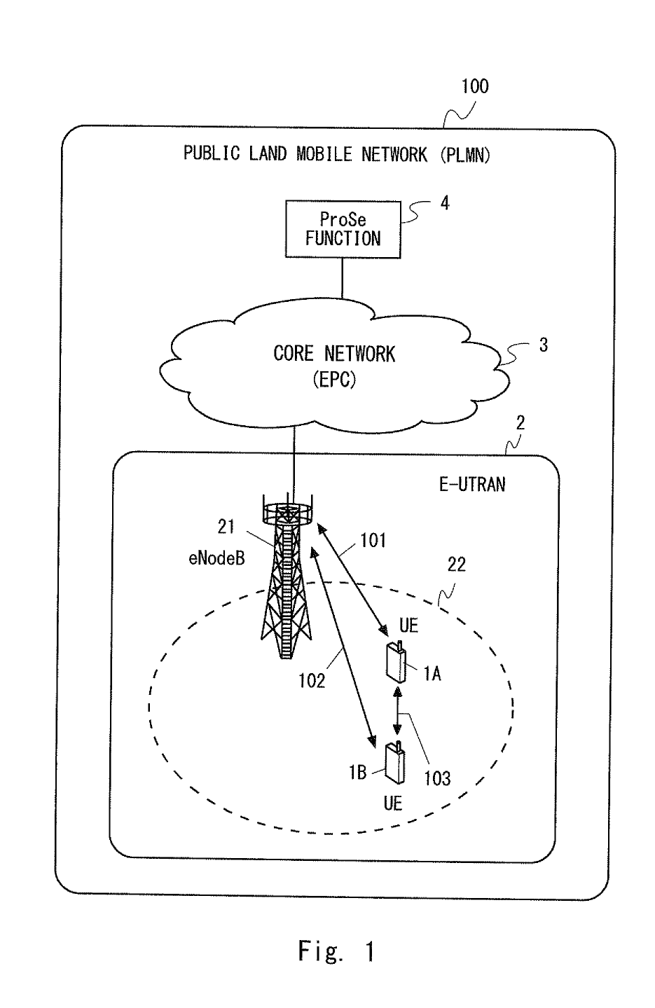

FIG. 1 shows a configuration example of a PLMN 100 according to this embodiment. Both a UE 1A and a UE 1B are radio terminals adapted to ProSe (ProSe-enabled UEs), and capable of establishing a ProSe communication path 103 and performing ProSe Direct Communication (ProSe communication, device to device direct communication, D2D communication) between them. The ProSe Direct Communication between the UE 1A and the UE 1B may be performed by using a radio communication technology that is also used to access a base station (eNodeB) 21 (i.e., E-UTRA technology) or by using a WLAN radio technology (IEEE 802.11 radio technology).

The eNodeB 21 is an entity located in a radio access network (i.e., E-UTRAN) 2, manages a cell 22 and is able to perform communication (101 and 102) with the UEs 1A and 1B by using the E-UTRA technology. While FIG. 1 shows the situation where both the UE 1A and UE 1B are located in the identical cell 22 for the sake of clarity, such a UE arrangement is merely an example.

A core network (i.e., EPC) 3 includes a plurality of user-plane entities (e.g., Serving Gateway (S-GW) and Packet Data Network Gateway (P-GW)), and a plurality of control-plane entities (e.g., Mobility Management Entity (MME) and Home Subscriber Server (HSS)). The user-plane entities relay user data of the UEs 1A and 1B between the E-UTRAN 2 and an external network (Packet Data Network (PDN)). The control plane entities perform various types of control for the UEs 1A and 1B including mobility management, session management (bearer management), subscriber information management, and billing management.

In order to use ProSe (e.g., one or both of EPC-level ProSe Discovery and ProSe Direct Communication), each of the UE 1A and the UE 1B attaches to the EPC 3 via the E-UTRAN 2, establishes a Packet Data Network (PDN) connection for communicating with a ProSe function entity 4, and transmits and receives ProSe control signaling to and from the ProSe function entity 4 through the E-UTRAN 2 and the EPC 3. The UE 1A and the UE 1B may use EPC-level ProSe Discovery provided by the ProSe function entity 4. The UE 1A and the UE 1B may receive from the ProSe function entity 4 a message indicating permission for the UE 1A and the UE 1B to activate (enable) ProSe Direct Discovery or ProSe Direct Communication. The UE 1A and the UE 1B may receive, from the ProSe function entity 4, configuration information for ProSe Direct Discovery or ProSe Direct Communication in the cell 22.

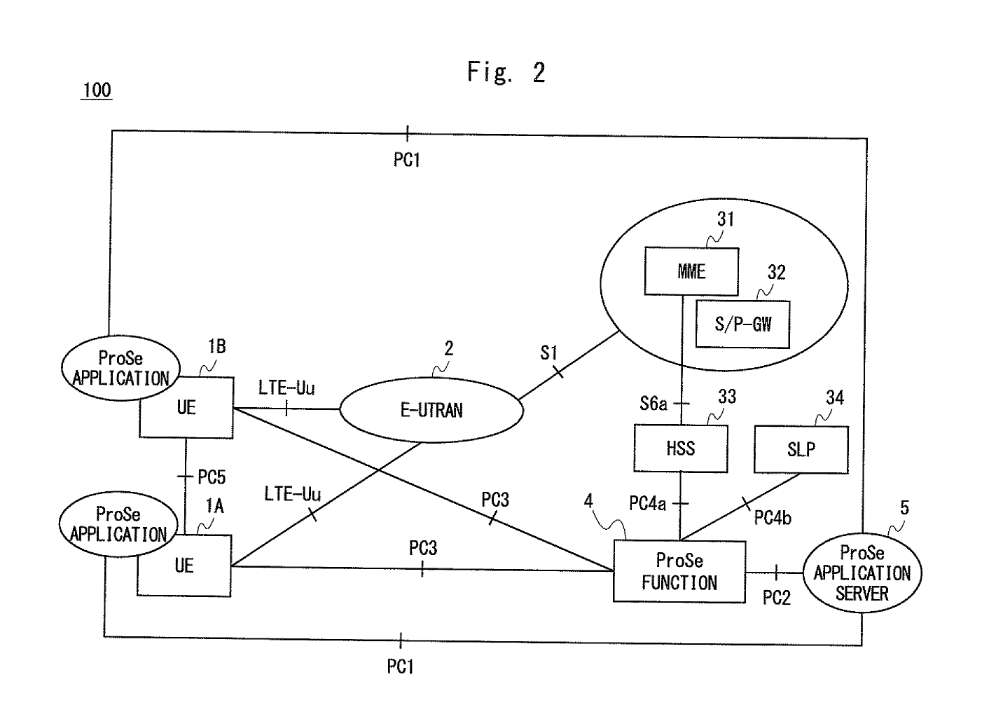

FIG. 2 shows reference points used for ProSe. Each reference point is also referred to as an “interface”. FIG. 2 shows a non-roaming architecture in which the UE 1A and the UE 1B use subscriptions of the identical PLMN 100.

A PC1 reference point is a reference point between a ProSe application in each UE 1 (the UE 1A and the UE 1B) and a ProSe application server 5. The PC1 reference point is used to define application-level signaling requirements.

A PC2 reference point is a reference point between the ProSe application server 5 and the ProSe function entity 4. The PC2 reference point is used to define interactions between the ProSe application server 5 and the ProSe functionality provided by the 3GPP EPS via the ProSe function entity 4.

A PC3 reference point is a reference point between each UE 1 (the UE 1A and the UE 1B) and the ProSe function entity 4. The PC3 reference point is used to define interactions (e.g., UE registration, application registration, and authorization for ProSe Direct Discovery and EPC-level ProSe Discovery requests) between each UE 1 and the ProSe function entity 4. The PC3 reference point depends on the user plane of the EPC 3 and, accordingly, ProSe control signaling between each UE 1 and the ProSe function entity 4 is transferred on the user plane.

A PC4a reference point is a reference point between the ProSe function entity 4 and an HSS 33. The PC4a reference point is used by the ProSe function entity 4, for example to acquire subscriber information related to ProSe services.

A PC4b reference point is a reference point between the ProSe function entity 4 and a Secure User Plane Location (SUPL) Location Platform (SLP) 34. The PC4b reference point is used by the ProSe function entity 4, for example, to acquire position information of each UE 1 (the UE 1A and the UE 1B). The SLP assists the UEs 1 in GPS positioning and receives measurement results from the UEs 1, thereby intermittently acquiring from the UEs 1 the position information by which the position of the UEs 1 can be estimated.

A PC5 reference point is a reference point between UEs 1 (ProSe-enabled UEs), and is used for the control and user planes of ProSe Direct Discovery, ProSe Direct Communication and ProSe UE-to-Network Relay.

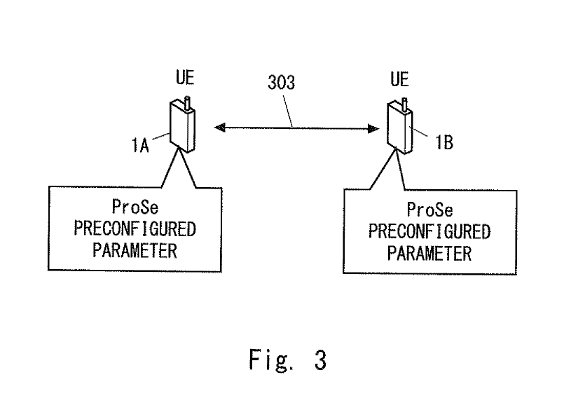

Each UE 1 according to this embodiment supports non-PLMN-assisted ProSe communication in the situation where connection to the PLMN 100 is unavailable (e.g., in out-of-coverage). As shown in FIG. 3, when each of the UE 1A and the UE 1B cannot detect any available PLMN (e.g., in out-of-coverage), the UE 1A and the UE 1B perform non-PLMN-assisted ProSe communication (i.e., one or both of ProSe Direct Discovery and ProSe Direct Communication) according to a ProSe preconfigured parameter(s) (303).

The ProSe preconfigured parameter(s) includes at least a radio parameter configuration. For example, the ProSe preconfigured parameter specifies at least one of: a frequency band identifier; a center frequency (E-UTRA Absolute Radio Frequency Channel Number (EARFCN)); maximum transmission power (P-MAX-ProSe); a Time Division Duplex (TDD) uplink-downlink configuration; and resource blocks (the number of resource blocks (Physical Resource Blocks (PRBs), an offset of Start PRB, and offset of End PRB). The ProSe preconfigured parameter(s) may include various radio parameters, other than the foregoing, such as those disclosed in Non-Patent Literature 2.

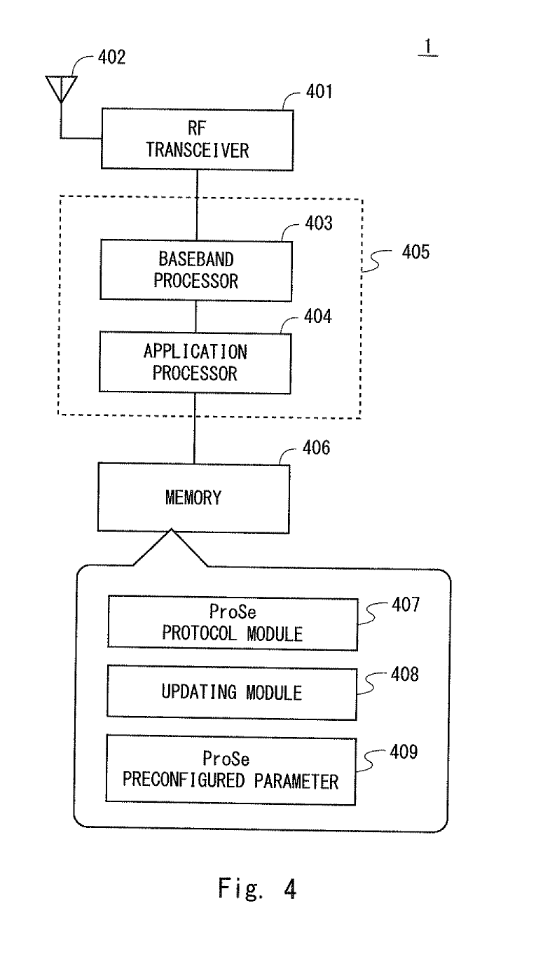

FIG. 4 is a block diagram showing a configuration example of the UE 1 according to this embodiment. A Radio Frequency (RF) transceiver 401 performs analog RF signal processing to communicate with the eNodeB 21 in the PLMN 100. The RF transceiver 401 may be used further for ProSe Direct Discovery and Direct Communication between UEs 1. The RF transceiver 401 may include a first transceiver used for communication with the eNodeB 21 in the PLMN 100, and a second transceiver used for ProSe Direct Discovery and Direct Communication between UEs 1. The analog RF signal processing performed by the RF transceiver 401 includes frequency up-conversion, frequency down-conversion, and amplification. The RF transceiver 401 is coupled to an antenna 402 and a baseband processor 403. That is, the RF transceiver 401 receives modulated symbol data (or OFDM symbol data) from the baseband processor 403, generates a transmission RF signal, and supplies the transmission RF signal to the antenna 402. Further, the RF transceiver 401 generates a baseband reception signal based on a reception RF signal received by the antenna 402, and supplies the baseband reception signal to the baseband processor 403.

The baseband processor 403 performs digital baseband signal processing (i.e., data plane processing) and control plane processing for wireless communication. The digital baseband signal processing includes (a) data compression/decompression, (b) data segmentation/concatenation, (c) composition/decomposition of a transmission format (i.e., transmission frame), (d) line coding/decoding, (e) modulation (i.e., symbol mapping)/demodulation, (f) spreading/de-spreading, and (g) generation of OFDM symbol data (i.e., baseband OFDM signal) by Inverse Fast Fourier Transform (IFFT). On the other hand, the control plane processing includes communication management of layer 1 (e.g., transmission power control), layer 2 (e.g., radio resource management, and hybrid automatic repeat request (HARQ) processing), and layer 3 (e.g., signaling relating to attach, mobility, and call management).

The baseband processor 403 may include a modem processor (e.g., a Digital Signal Processor (DSP)) that performs the digital baseband signal processing and a protocol stack processor (e.g., Central Processing Unit (CPU) or Micro Processing Unit (MPU)) that performs the control plane processing. In this case, the protocol stack processor, which performs the control plane processing, may be integrated with an application processor 404 described in the following.

The application processor 404 is also referred to as a CPU, MPU, microprocessor, or processor core. The application processor 404 may include a plurality of processors (processor cores). The application processor 404 loads a system software program (Operating System (OS)) and various application programs (e.g., a voice call application, a WEB browser, a mailer, a camera operation application, a music player application, and a video player application) from a memory 406 or from other memories (not shown) and executes these programs, thereby providing various functions of the UE1.

In some implementations, as represented by a dashed line (405) in FIG. 4, the baseband processor 403 and the application processor 404 may be integrated on a single chip. In other words, the baseband processor 403 and the application processor 404 may be implemented in a single System on Chip (SoC) device 405. A SoC device may also be referred to as a system Large Scale Integration (LSI) or a chipset.

The memory 406 is a memory coupled to the UE 1. The memory 406 is a volatile memory, a nonvolatile memory, or a combination thereof. The volatile memory is, for example, a Static Random Access Memory (SRAM), a Dynamic RAM (DRAM), or a combination thereof. The nonvolatile memory is a Mask Read Only Memory (MROM), an Electrically Erasable Programmable ROM (EEPROM), a flash memory, a hard disk drive, or any combination thereof. The memory 406 may include a plurality of memory devices that are physically independent from each other. For example, the memory 406 may include an external memory device that is accessible from the baseband processor 403, the application processor 404, and the SoC 405. The memory 406 may include an internal memory device that is integrated in the baseband processor 403, the application processor 404, or the SoC 405. The memory 406 may include a memory in a UICC.

The memory 406 stores a ProSe protocol module 407, an updating module 408, and a ProSe preconfigured parameter(s) 409. As described above, the memory 406 may include a plurality of memory devices that are physically independent from each other, and these software and data may be stored in an identical memory device or separate memory devices.

The ProSe protocol module 407 includes a software module to be executed by the baseband processor 403 or the application processor 404. Thus, the baseband processor 403 or the application processor 404 communicates with the ProSe function entity 4, the MME 31, and the eNodeB 21 to perform ProSe communication (e.g., EPC-level ProSe Discovery, ProSe Direct Discovery, ProSe Direct Communication) assisted by the PLMN 100 within the coverage of the PLMN 100 and to also perform a registration procedure necessary for this ProSe communication. Further, in the situation where connection to the PLMN 100 is unavailable (e.g., out-of-coverage), the baseband processor 403 or the application processor 404 performs one or both of non-PLMN-assisted ProSe Direct Discovery and non-PLMN-assisted ProSe Direct Communication according to the ProSe preconfigured parameter(s) 409. As has already been described above, the ProSe preconfigured parameter(s) 409 includes at least a radio parameter configuration.

The UE 1 may include, in addition to the RF transceiver 401 (e.g., LTE transceiver), another RF transceiver (e.g., Wireless Local Area Network (WLAN) transceiver, TErrestrial Trunked Radio (TETRA) transceiver, or Near-Field Communication (NFC) transceiver), and may use this other RF transceiver to perform at least one of PLMN-assisted ProSe communication (e.g., in-coverage) and non-PLMN-assisted ProSe communication (e.g., out-of-coverage).

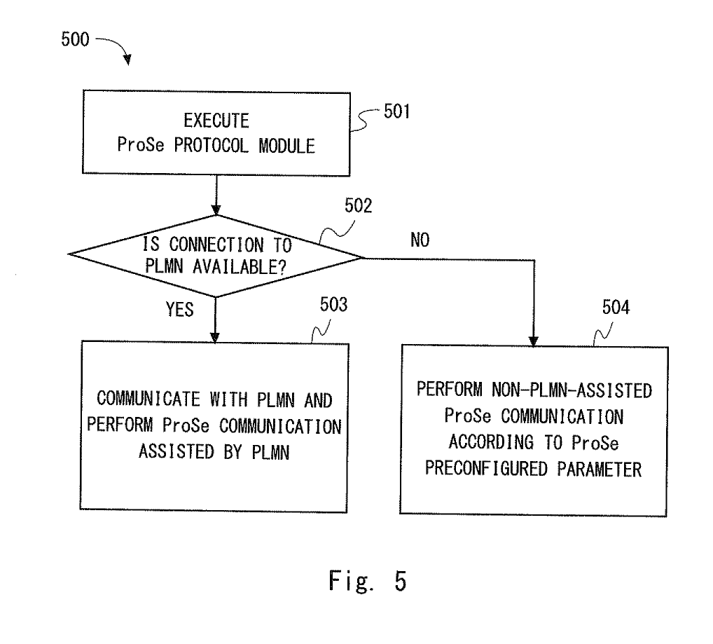

FIG. 5 is a flowchart showing an example of a procedure (process 500) performed by the UE 1 for executing ProSe communication. In block 501, the application processor 404 (or the baseband processor 403) executes the ProSe protocol module 407. When the UE 1 can connect to the PLMN 100 (e.g., in-coverage) (YES in block 502), the application processor 404 (or the baseband processor 403), which executes the ProSe protocol module 407, communicates with the PLMN 100 and performs ProSe communication (one or both of Discovery and Direct Communication) assisted by the PLMN 100 (block 503). When the UE 1 cannot connect to the PLMN 100 (e.g., out-of-coverage) (NO in block 502), the application processor 404 (or the baseband processor 403) reads the ProSe preconfigured parameter(s) 409 from the memory 406 and performs non-PLMN-assisted ProSe communication (one or both of Discovery and Direct Communication) according to the ProSe preconfigured parameter(s) 409 (block 504).

The UE 1 may determine that it cannot connect to the PLMN 100 based on detecting that the reception quality (e.g., Reference Signal Received Power (RSRP) or Reference Signal Received Quality (RSRQ)) of a radio signal transmitted from any eNodeB 21 in the PLMN 100 is equal to or lower than a predetermined threshold value. In other words, the UE 1 may determine that it cannot connect to the PLMN 100 in response to detecting that the UE 1 has not successfully received the radio signal from the PLMN 100. Alternatively, the UE 1 may determine that it cannot connect to the PLMN 100 based on detecting that a connection to the PLMN 100 (e.g., attach to the EPC 3) has been rejected while the UE 1 could receive a signal from the eNodeB 21. Alternatively, the UE 1 may determine that it cannot connect to the PLMN 100 based on detecting that the UE 1 has not successfully communicated with the ProSe function entity 4 while the UE 1 has been allowed to connect to the PLMN 100. Alternatively, the UE 1 may determine that it cannot connect to the PLMN 100 based on detecting that the UE 1 has disconnected or deactivated its connection to the PLMN 100 according to an instruction from the user or the PLMN 100 (e.g., the ProSe function entity 4 or an Operation Administration and Maintenance (OAM) server).

Referring again to FIG. 4, the updating module 408 includes a software module that is executed by any one of the processors. Any one of the processors executes the updating module 408, thereby updating the ProSe preconfigured parameter(s) 409.

In some implementations, the updating module 408 may be executed by the baseband processor 403 or the application processor 404.

In some implementations, the updating module 408 may be executed by a processor other than the baseband processor 403 and the application processor 404 that perform ProSe communication. For example, the updating module 408 may be executed by a processor embedded in a UICC. In particular when the baseband processor 403 and the application processor 404 are implemented in a single-Chip SoC device 405, the updating module 408 may be executed by a processor integrated on a chip other than the SoC device 405.

The configuration in which a processor other than the processor(s) performing ProSe communication (i.e., the baseband processor 403 and the application processor 404) executes the updating module 408 has the following advantage. As has already been described above, in some implementations, the ProSe preconfigured parameter(s) 409 is stored in a UICC. However, any limitations may be imposed on the Application Programing Interface (API) for UICC access which is provided by the application processor 404 (or the baseband processor 403 or the SoC 405). That is, the application processor 404 (or the baseband processor 403 or the SoC 405) may not permit third-party application programs including the updating module 408 to access the UICC for updating data (i.e., the ProSe preconfigured parameter(s) 409) in the UICC. The configuration in which a processor embedded in the UICC (or a processor integrated on a chip other than the SoC device 405) executes the updating module 408 enables updating of the ProSe preconfigured parameter(s) 409 without passing via the SoC device 405. Further, this configuration allows non-PLMN-assisted ProSe communication performed by the SoC device 405 to be controlled from outside the SoC device 405 using the updated ProSe preconfigured parameter(s) 409.

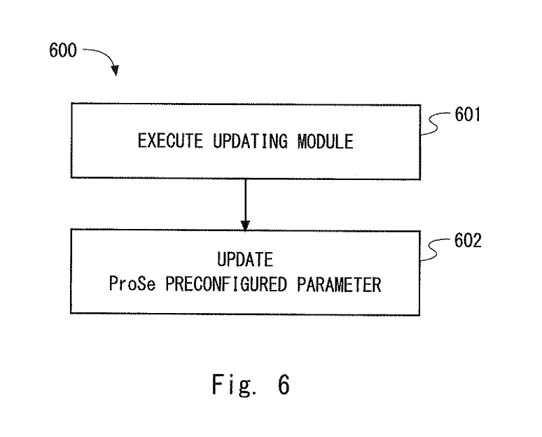

FIG. 6 is a flowchart showing an example of a procedure (process 600) performed by the UE 1 for updating the ProSe preconfigured parameter(s) 409. In block 601, the baseband processor 403, the application processor 404, or another processor executes the updating module 408. In block 602, the processor executing the updating module 408 updates the ProSe preconfigured parameter(s) 409.

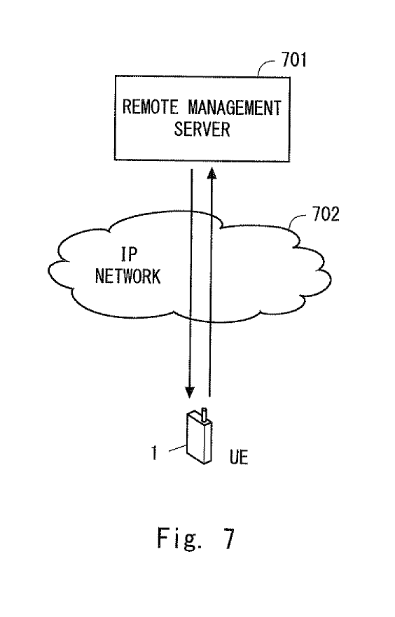

In some implementations, as shown in FIG. 7, the UE 1 (i.e., the updating module 408 or the processor executing the updating module 408) may communicate with a remote management server (remote administration server) 701, via an Internet Protocol (IP) network 702, to update the ProSe preconfigured parameter 409 according to an instruction from the remote management server 701. For example, the remote management server 701 may determine the ProSe preconfigured parameter 409 based on one or both of the time and place where the UE 1 performs non-PLMN-assisted ProSe communication, and notify the UE 1 of the determined ProSe preconfigured parameter 409. The IP network 702 may involve the PLMN 100. That is, the UE 1 may communicate with the remote management server 701 via the PLMN 100 using the RF transceiver 801. Alternatively, the network 702 may involve another network (e.g., a Wireless Local Area Network (WLAN), a TETRA system, or a P25 system). That is, the UE 1 may communicate with the remote management server 701 via a network other than the PLMN 100. In this case, the UE 1 may be equipped with a transceiver and a modem for communicating with the other network. Further, the remote management server 701 may be the server that implements the ProSe function entity 4. The functions of the remote management server 701 may form part of the ProSe function entity 4.

Additionally or alternatively, the UE 1 (i.e., the updating module 408 or the processor executing the updating module 408) may acquire, from the baseband processor 403, the application processor 404, or the ProSe protocol module 407, a radio parameter(s) for PLMN-assisted ProSe communication that has been sent from the PLMN 100 (e.g., the eNodeB 21), and update the ProSe preconfigured parameter(s) 409 based on this radio parameter(s) for PLMN-assisted ProSe communication. The radio parameter(s) for PLMN-assisted ProSe communication may be transmitted using system information (System Information Block (SIB)) that is broadcasted by the eNodeB 21.

Additionally or alternatively, the UE 1 (i.e., the updating module 408 or the processor executing the updating module 408) may update the ProSe preconfigured parameter(s) 409 according to an instruction from the user via an interface provided by the UE 1.

Additionally or alternatively, the UE 1 (i.e., the updating module 408 or the processor executing the updating module 408) may autonomously determine whether it is necessary to update the ProSe preconfigured parameter(s) 409. For example, the UE 1 may update the ProSe preconfigured parameter(s) 409 based on one or both of the time and place where the UE 1 performs non-PLMN-assisted ProSe communication.

As can be understood from the foregoing description, in this embodiment, the UE 1 has the updating module 408, and updates the ProSe preconfigured parameter(s) 409 including the pre-configuration of a radio parameter(s) for non-PLMN-assisted ProSe communication. That is, the UE 1 can dynamically update the ProSe preconfigured parameter(s) 409. For example, the ProSe preconfigured parameter(s) 409 may be updated according to any condition under which non-PLMN-assisted ProSe communication is performed (e.g., the number of UE groups existing in proximity to one another). Thus, the UE 1 can flexibly adapt to the condition under which non-PLMN-assisted ProSe communication is performed (e.g., the number of UE groups existing in proximity to one another). For example, when the number of UE groups existing in close proximity within an identical area is small, the UE 1 may update the ProSe preconfigured parameter(s) 409 so that a relatively larger amount of radio resources becomes available for the UE 1. Conversely, when the number of UE groups existing in close proximity within an identical area is large, the UE 1 may update the ProSe preconfigured parameter(s) 409 so that a relatively smaller amount of radio resources becomes available for the UE 1.

### Second Embodiment

This embodiment provides a specific example of configuration and operation for updating the ProSe preconfigured parameter(s) described in the first embodiment. A configuration example of a network according to this embodiment is similar to that shown in FIGS. 1 to 3. In this embodiment, the updating module for updating the ProSe preconfigured parameter is executed by a processor embedded in a UICC.

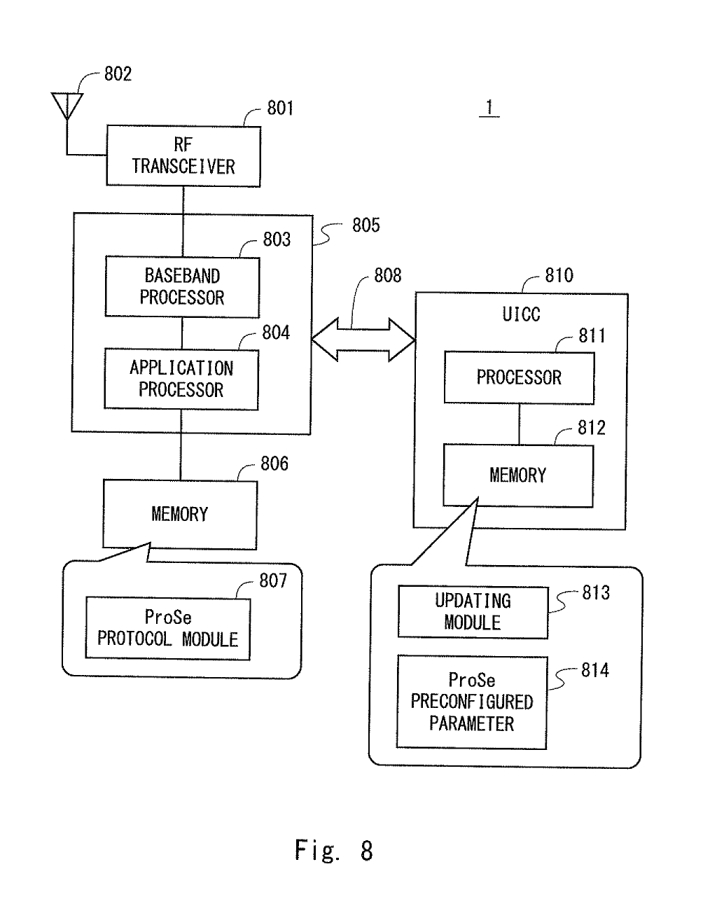

FIG. 8 is a block diagram showing a configuration example of the UE 1 according to this embodiment. The configurations and operations of an RF transceiver 801, an antenna 802, a baseband processor 803, an application processor 804, a SoC device 805 and a memory 806 shown in FIG. 8 are similar to those of the corresponding elements shown in FIG. 4. The baseband processor 803 and the application processor 804 are configured to communicate with a UICC 810 via an interface 808. The memory 806 stores a ProSe protocol module 807.

The ProSe protocol module 807 is executed by the baseband processor 803 or the application processor 804. The baseband processor 803 or the application processor 804 executes the ProSe protocol module 807, thereby performing ProSe communication assisted by the PLMN 100 within the coverage of the PLMN 100. Further, in the situation where connection to the PLMN 100 is unavailable (e.g., out-of-coverage), the baseband processor 803 or the application processor 804 performs one or both of non-PLMN-assisted ProSe Direct Discovery and non-PLMN-assisted ProSe Direct Communication according to a ProSe preconfigured parameter(s) 814 which will be described later.

The UICC 810 includes a processor 811 and a memory 812. The memory 812 is a volatile memory, a nonvolatile memory, or a combination thereof. The memory 812 may include a plurality of memory devices that are physically independent from each other. The memory 812 stores an updating module 813 and the ProSe preconfigured parameter(s) 814. The ProSe preconfigured parameter(s) 814 includes at least a radio parameter configuration, and is used by the baseband processor 803 or the application processor 804 to perform non-PLMN-assisted ProSe communication. While not shown in FIG. 8, the memory 812 may store other application program modules including a SIM application, a USIM application, and a SIM application toolkit (SAT) application. These program modules are executed by the processor 811.

The updating module 813 stored in the UICC 810 is executed by the processor 811 in the UICC 810. The processor 811 executes the updating module 813, thereby updating the ProSe preconfigured parameter(s) 814.

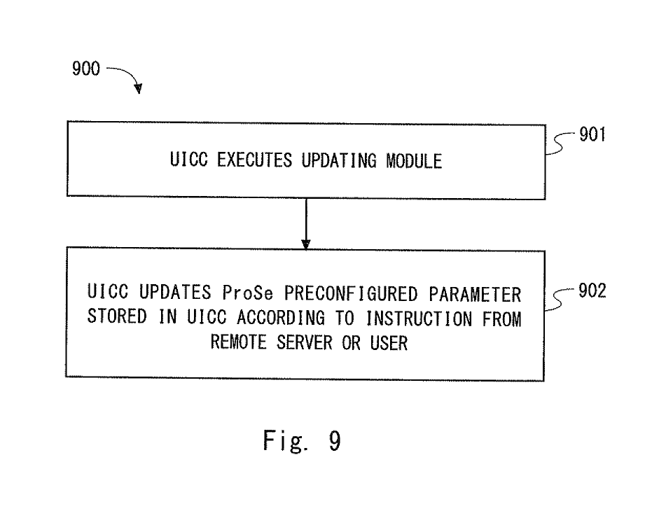

FIG. 9 is a flowchart showing an example of a procedure (process 900) performed by the UE 1 for updating the ProSe preconfigured parameter(s) 814. In block 901, the processor 811 in the UICC 810 executes the updating module 813. In block 902, the processor 811 executing the updating module 813 updates the ProSe preconfigured parameter(s) 814 stored in the UICC 810.

As described in this embodiment, the configuration in which the processor 811 embedded in the UICC 810 executes the updating module 813 enables updating of the ProSe preconfigured parameter(s) 814 without passing via the SoC device 805. Further, this configuration allows the processor 811 to control non-PLMN-assisted ProSe communication performed by the SoC device 805 from outside the SoC device 805, using the updated ProSe preconfigured parameter 814.

### Third Embodiment

This embodiment provides a specific example of configuration and operation for updating the ProSe preconfigured parameter(s) described in the first embodiment. A configuration example of a network according to this embodiment is similar to that shown in FIGS. 1 to 3.

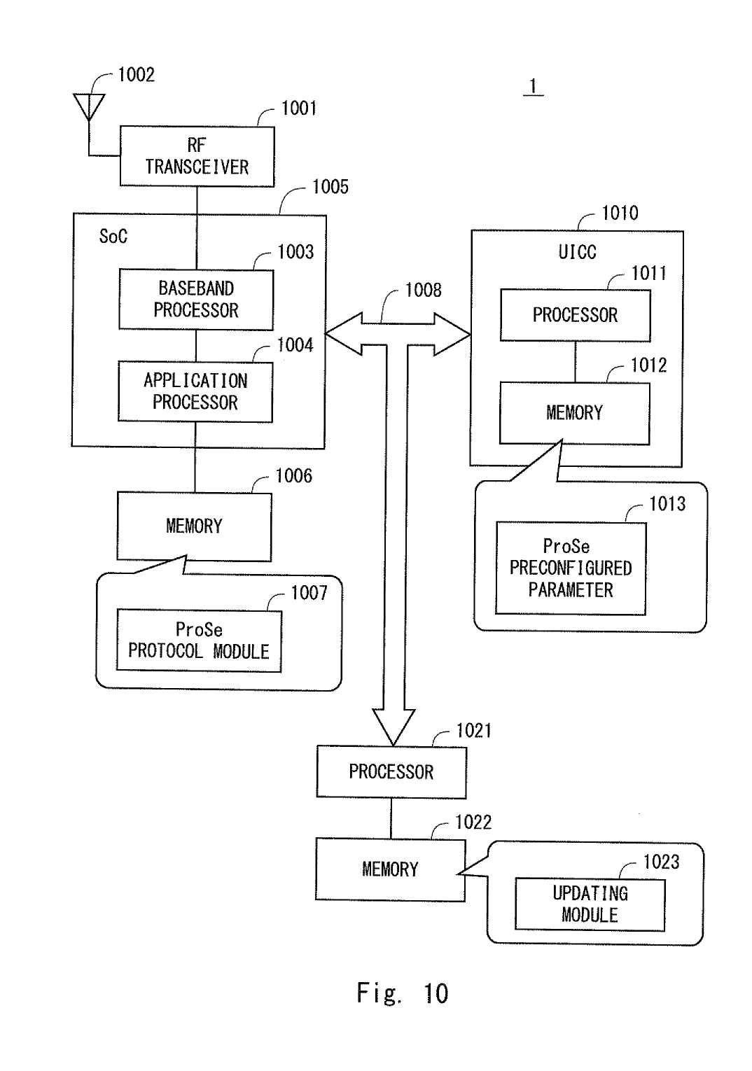

FIG. 10 is a block diagram showing a configuration example of the UE 1 according to this embodiment. The configurations and operations of an RF transceiver 1001, an antenna 1002, a baseband processor 1003, an application processor 1004, a SoC device 1005, and a memory 1006 shown in FIG. 10 are similar to those of the corresponding elements shown in FIG. 4. The baseband processor 1003 and the application processor 1004 are configured to communicate with a UICC 1010 via an interface 1008. The memory 1006 stores a ProSe protocol module 1007.

The ProSe protocol module 1007 is executed by the baseband processor 1003 or the application processor 1004. The baseband processor 1003 or the application processor 1004 executes the ProSe protocol module 1007, thereby performing ProSe communication assisted by the PLMN 100 within the coverage of the PLMN 100. Further, in the situation where connection to the PLMN 100 is unavailable (e.g., out-of-coverage), the baseband processor 1003 or the application processor 1004 performs one or both of ProSe Direct Discovery and ProSe Direct Communication according to a ProSe preconfigured parameter(s) 1013 which will be described later.

The UICC 1010 includes a processor 1011 and a memory 1012. The memory 1012 is a volatile memory, a nonvolatile memory, or a combination thereof. The memory 1012 may include a plurality of memory devices that are physically independent from each other. The memory 1012 stores the ProSe preconfigured parameter(s) 1013. The ProSe preconfigured parameter(s) 1013 includes at least a radio parameter configuration, and is used by the baseband processor 1003 or the application processor 1004 to perform non-PLMN-assisted ProSe communication. While not shown in FIG. 10, the memory 1012 may store other application program modules including a SIM application, a USIM application, and a SAT application. These program modules are executed by the processor 1011.

A processor 1021 is integrated on a chip other than the SoC device 1005 including the baseband processor 1003 and the application processor 1004, which perform ProSe communication. The processor 1021 reads an updating module 1023 from a memory 1022 and executes the updating module 1023, thereby updating the ProSe preconfigured parameter(s) 1013 stored in the UICC 1010. The memory 1022 may be the memory device identical to the memory 1006.

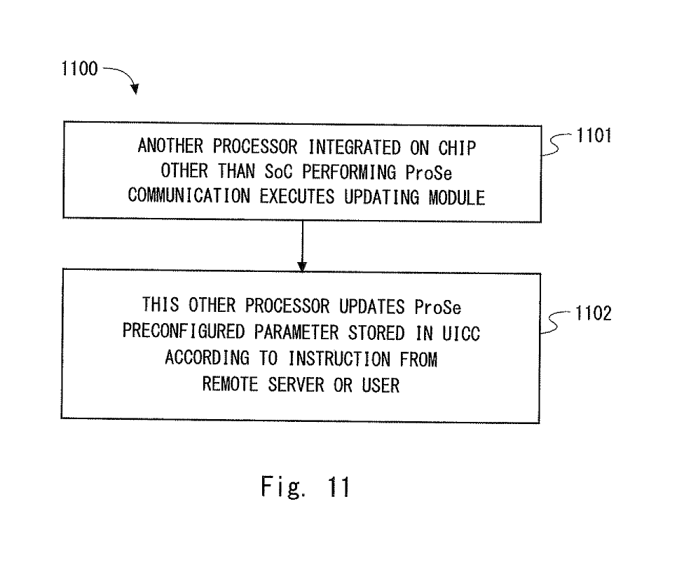

FIG. 11 is a flowchart showing an example of a procedure (process 1100) performed by the UE 1 for updating the ProSe preconfigured parameter 1013. In block 1101, the processor 811 in the UICC 810 executes the updating module 813. In block 902, the processor 1021 integrated on the chip other than the SoC 1005, which performs ProSe communication, executes the updating module 1023. In block 1102, the processor 1021 executing the updating module 1023 updates the ProSe preconfigured parameter(s) 1013 stored in the UICC 1010.

As described in this embodiment, the configuration in which the processor 1021 integrated on a chip other than the SoC 1005, which performs ProSe communication, executes the updating module 1023 enables updating of the ProSe preconfigured parameter(s) 1013 without passing via the SoC device 1005. Further, this configuration allows the processor 1021 to control non-PLMN-assisted ProSe communication performed by the SoC device 1005 from outside the SoC device 1005, using the updated ProSe preconfigured parameter 1013.

### Fourth Embodiment

This embodiment provides a specific example of configuration and operation for updating the ProSe preconfigured parameter(s) described in the first embodiment. A configuration example of a network according to this embodiment is similar to that shown in FIGS. 1 to 3. In this embodiment, the UE 1 retains a master configuration for non-PLMN-assisted ProSe communication, and selects, out of the radio resources specified by the master configuration, a radio resource to be included in the ProSe preconfigured parameter(s). That is, in this embodiment, the radio resource specified by the ProSe preconfigured parameter(s) is a subset of the radio resources specified by the master configuration.

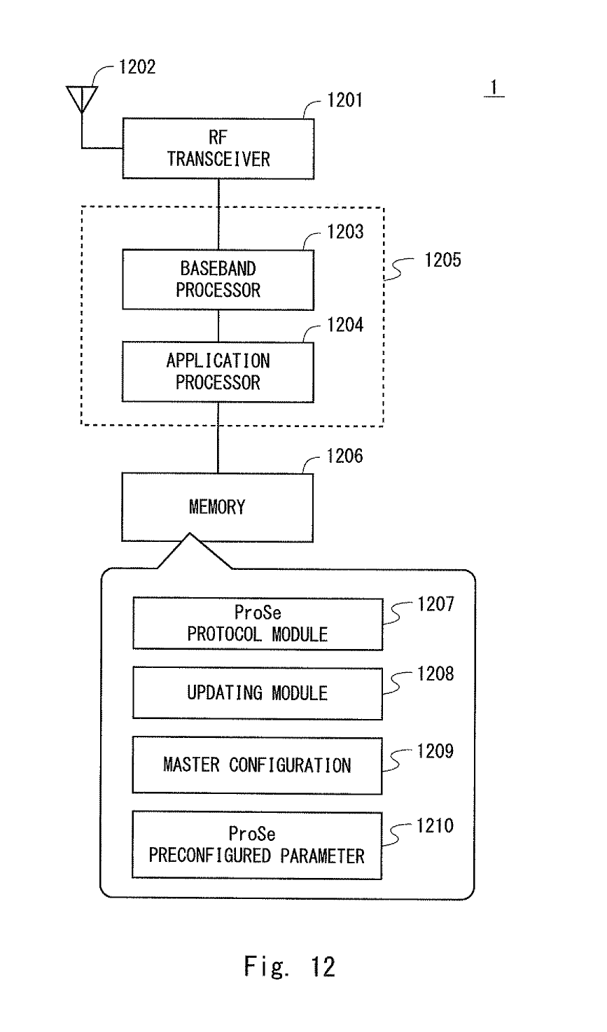

FIG. 12 is a block diagram showing a configuration example of the UE 1 according to this embodiment. The configurations and operations of an RF transceiver 1201, an antenna 1202, a baseband processor 1203, an application processor 1204, a SoC device 1205, and a memory 1206 shown in FIG. 12 are similar to those of the corresponding elements shown in FIG. 4. The memory 1206 stores a ProSe protocol module 1207, an updating module 1208, a master configuration 1209, and a ProSe preconfigured parameter(s) 1210.

In some implementations, the updating module 1208 may be executed by the baseband processor 1203 or the application processor 1204. Alternatively, similarly to the second or third embodiment, the ProSe preconfigured parameter(s) 1210 may be updated by a processor embedded in the UICC or by a processor integrated on a chip other than the SoC1205. The ProSe preconfigured parameter(s) 1210 according to this embodiment may be stored in the UICC.

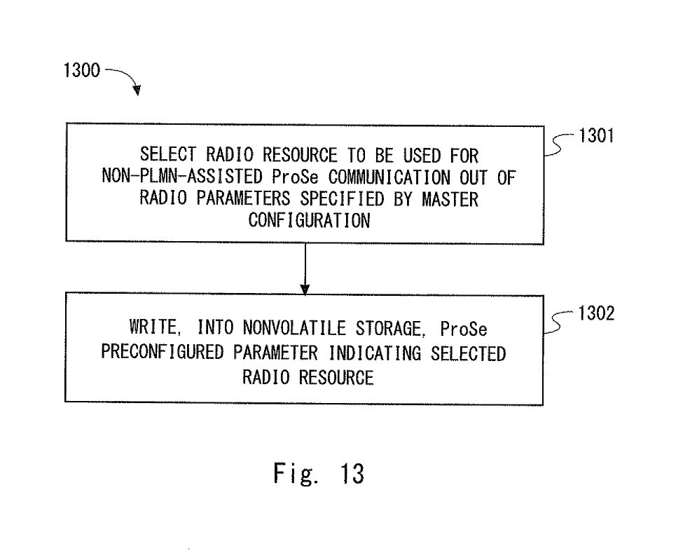

FIG. 13 is a flowchart showing an example of a procedure (process 1300) performed by the UE 1 for updating the ProSe preconfigured parameter(s) 1210. In block 1301, the baseband processor 1203, the application processor 1204, or another processor executes the updating module 1208. Thus, the processor executing the updating module 1208 selects, out of the radio resources specified by the master configuration, a radio to be resource used for non-PLMN-assisted ProSe communication. In block 1302, the processor executing the updating module 1208 writes into the memory the ProSe preconfigured parameter(s) 1210 indicating the selected radio resource.

The processor executing the updating module 1208 may select, out of the radio resources specified by the master configuration 1209, a radio resource to be included in the ProSe preconfigured parameter(s) 1210, based on the magnitude of interference that the UE 1 is subjected to. Additionally or alternatively, the processor executing the updating module 1208 may select, out of the radio resources specified by the master configuration 1209, a radio resource to be included in the ProSe preconfigured parameter(s) 1210, based on the radio quality measured by the UE 1. With these operations, a radio resource that is expected to provide good radio quality can be used for non-PLMN-assisted ProSe communication performed by the UE 1.

Further, by the UE 1 keeping the master configuration 1209, when any failure or trouble has occurred in non-PLMN-assisted ProSe communication based on the current ProSe preconfigured parameter(s) 1210, the UE 1 can easily update the ProSe preconfigured parameter(s) 1210 based on the master configuration 1209. For example, when the magnitude of interference in non-PLMN-assisted ProSe communication based on a certain ProSe preconfigured parameter(s) 1210 has increased, the UE 1 may update the ProSe preconfigured parameter(s) 1210 so as to replace the radio resource to be used for the non-PLMN-assisted ProSe communication with another radio resource specified by the master configuration 1209.

### Fifth Embodiment

This embodiment provides a modification of the fourth embodiment. The master configuration described in the fourth embodiment may be managed not by the UE 1 but by a remote management server.

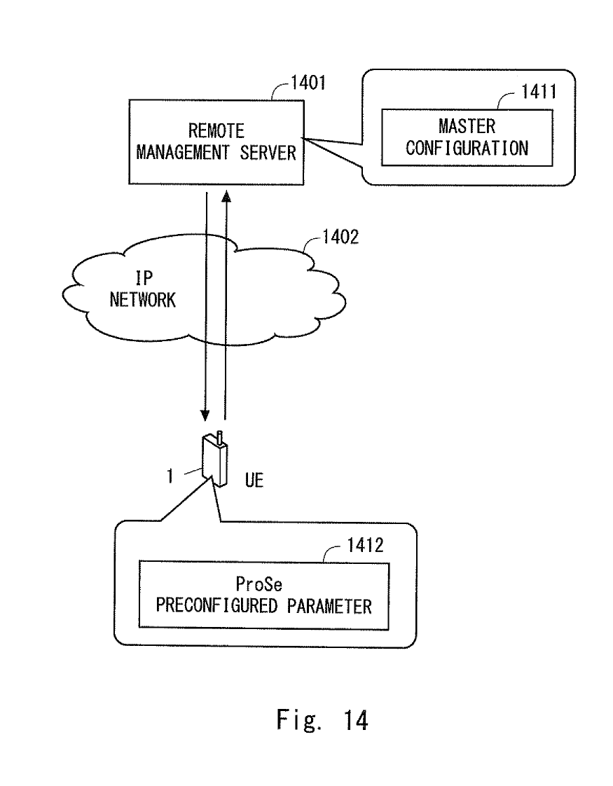

FIG. 14 is a diagram showing a configuration example for updating a ProSe preconfigured parameter(s) according to this embodiment. The UE 1 retains a ProSe preconfigured parameter(s) 1412 used for non-PLMN-assisted ProSe communication. On the other hand, a remote management server 1401 retains a master configuration 1411. The remote management server 1401 communicates with the UE 1 via an IP network 1402, and requests the UE 1 to update the ProSe preconfigured parameter(s) 1412. The IP network 1402 may involve the PLMN 100 or may involve another network (e.g., a WLAN, a TETRA system, or a P25 system).

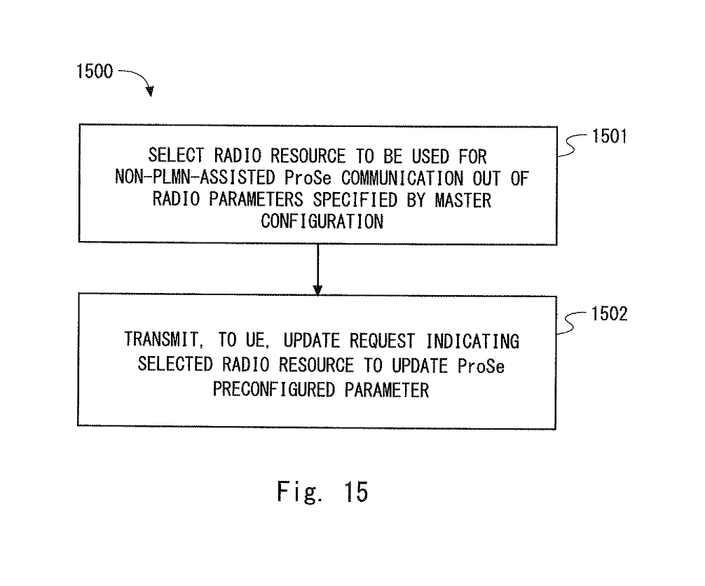

FIG. 15 is a flowchart showing an example of a procedure (process 1500) performed by the UE 1 for updating the ProSe preconfigured parameter(s) 1412. In block 1501, the remote management server 1401 selects, out of the radio parameters specified by the master configuration 1411, a radio resource to be used for non-PLMN-assisted ProSe communication. In block 1502, the remote management server 1401 transmits to the UE 1 an update request indicating the selected radio resource to update the ProSe preconfigured parameter(s) 1412 retained by the UE 1.

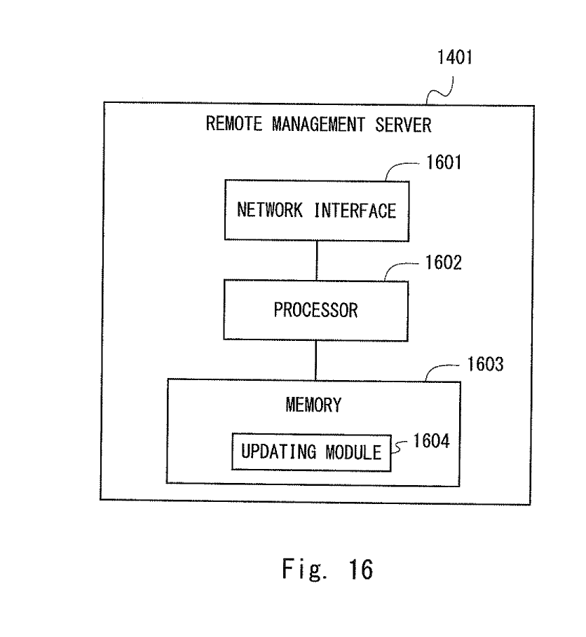

FIG. 16 shows a configuration example of the remote management server 1401. Referring to FIG. 16, the remote management server 1401 includes a network interface 1601, a processor 1602, and a memory 1603. The network interface 1601 is used to communicate with the UE1 through the IP network 1402. The network interface 1601 may include, for example, a Network Interface Card (NIC) conforming to the IEEE 802.3 series.

The processor 1602 loads software (computer program) from the memory 1603 and executes these loaded software, and thereby performs processes of the remote management server 1401 explained in this embodiment. The processor 1602 may be, for example, a microprocessor, an MPU, or a CPU. The processor 1602 may include a plurality of processors.

The memory 1603 consists of a combination of a volatile memory and a nonvolatile memory. The volatile memory is, for example, a Static Random Access Memory (SRAM), a Dynamic RAM (DRAM), or a combination thereof. The nonvolatile memory is, for example, an MROM, a Programmable ROM (PROM), a flash memory, a hard disk drive, or any combination thereof. The memory 1603 may include a storage that is remotely arranged from the processor 1602. In this case, the processor 1602 may access the memory 1603 through an I/O interface (not shown)

In the example shown in FIG. 16, the memory 1603 is used to store software modules including an updating module 1604. The updating module 1604 includes instructions and data necessary for performing processes of the remote management server 1401 explained in this embodiment. The processor 1602 loads software modules including the updating module 1604 from the memory 1603 and executes these loaded modules, and thereby performing the processes of the remote management server 1401 explained in this embodiment.

The remote server 1401 may select, out of the radio resources specified by the master configuration 1411, a radio resource to be included in the ProSe preconfigured parameter(s) 1412, based on the magnitude of interference that the UE 1 is subjected to. Additionally or alternatively, the remote server 1401 may select, out of the radio resources specified by the master configuration 1411, a radio resource to be included in the ProSe preconfigured parameter(s) 1412, based on the radio quality measured by the UE 1. With these operations, a radio resource that is expected to provide good radio quality can be used for non-PLMN-assisted ProSe communication performed by the UE 1.

Further, by the remote server 1401 keeping the master configuration 1411, when any failure or trouble has occurred in non-PLMN-assisted ProSe communication based on the current ProSe preconfigured parameter(s) 1412, the remote server 1401 can easily update the ProSe preconfigured parameter(s) 1412 based on the master configuration 1411.

Further, by the remote server 1401 keeping the master configuration 1411, the remote server 1401 can easily arbitrate the allocation of radio resources to a plurality of UE groups.

### Other Embodiments

Each of the above-described embodiments may be used individually, or two or more of the embodiments may be appropriately combined with one another.

Each of the processors included in the UE1, the UICCs 810 and 1010, the processor 1021, and the remote management servers 701 1401 according to the above-described embodiments executes one or more programs including instructions to cause a computer to perform an algorithm explained with reference to the drawings. These programs may be stored in various types of non-transitory computer readable media and thereby supplied to computers. The non-transitory computer readable media includes various types of tangible storage media. Examples of the non-transitory computer readable media include a magnetic recording medium (such as a flexible disk, a magnetic tape, and a hard disk drive), a magneto-optic recording medium (such as a magneto-optic disk), a Compact Disc Read Only Memory (CD-ROM), CD-R, CD-R/W, and a semiconductor memory (such as a mask ROM, a Programmable ROM (PROM), an Erasable PROM (EPROM), a flash ROM, and a Random Access Memory (RAM)). These programs may be supplied to computers by using various types of transitory computer readable media. Examples of the transitory computer readable media include an electrical signal, an optical signal, and an electromagnetic wave. The transitory computer readable media can be used to supply programs to a computer through a wire communication path such as an electrical wire and an optical fiber, or wireless communication path.

The above-described embodiments are explained by using specific examples mainly related to the EPS. However, these embodiments may be applied to other mobile communication systems such as a Universal Mobile Telecommunications System (UMTS), a 3GPP 2 CDMA2000 system (1xRTT, High Rate Packet Data (HRPD)), a Global System for Mobile communications (GSM)/General packet radio service (GPRS) system, and a mobile WiMAX system.

The above-described illustrative embodiments are merely examples of applications of the technical ideas obtained by the inventors. The technical ideas are not limited to the above-described illustrative embodiments, and various modifications can be made thereto.

This application is based upon and claims the benefit of priority from Japanese Patent Application No. 2015-022415, filed on Feb. 6, 2015, the disclosure of which is incorporated herein in its entirety by reference.

### REFERENCE SIGNS LIST

1, 1A, 1B USER EQUIPMENT (UE)
2 EVOLVED UNIVERSAL TERRESTRIAL RADIO ACCESS NETWORK (E-UTRAN)
3 EVOLVED PACKET CORE (EPC)
4 PROXIMITY-BASED SERVICES (PROSE) FUNCTION ENTITY
21 EVOLVED NODEB (ENODEB)
100 PUBLIC LAND MOBILE NETWORK (PLMN)
103, 303 PROSE DIRECT COMMUNICATION PATH
401, 801, 1001, 1201 RADIO FREQUENCY (RF) TRANSCEIVER
403, 803, 1003, 1203 BASEBAND PROCESSOR
404, 804, 1004, 1204 APPLICATION PROCESSOR
405, 805, 1005, 1205 SYSTEM ON CHIP (SOC) DEVICE
406, 806, 1006, 1022, 1206 MEMORY
407, 807, 1007, 1207 PROSE PROTOCOL MODULE
408, 813, 1023, 1208 UPDATING MODULE
409, 814, 1013, 1210, 1412 PROSE PRECONFIGURED PARAMETER(S)
701, 1401 REMOTE MANAGEMENT SERVER
910 UNIVERSAL INTEGRATED CIRCUIT CARD (UICC)
801, 1011, PROCESSOR IN UICC
1021 PROCESSOR
1209, 1411 MASTER CONFIGURATION

What is claimed is:

1. A radio terminal comprising:
at least one radio transceiver including a radio transceiver for communicating with a Public Land Mobile Network (PLMN);
at least one processor coupled to the at least one radio transceiver;
a protocol module including a software module to be executed by the at least one processor, the protocol module being configured to perform, using the at least one radio transceiver, at least one of PLMN-assisted discovery and PLMN-assisted direct communication within a coverage of the PLMN, the protocol module being configured to perform, using the at least one radio transceiver, at least one of non-PLMN-assisted discovery and non-PLMN-assisted direct communication according to a preconfigured radio parameter; and
an updating module configured to update the preconfigured radio parameter stored in a memory coupled to the radio terminal.

2. The radio terminal according to claim 1, wherein the updating module includes a first software module executed by the at least one processor.

3. The radio terminal according to claim 1, wherein
the memory includes a Universal Integrated Circuit Card (UICC), the preconfigured radio parameter is stored in the UICC, and
the updating module includes a second software module executed by the UICC.

4. The radio terminal according to claim 1, wherein
the at least one processor is integrated on a single System on Chip (SoC),
the memory includes a Universal Integrated Circuit Card (UICC), the preconfigured radio parameter is stored in the UICC,
the radio terminal further comprises a second processor integrated on a chip other than the SoC, and
the updating module includes a third software module executed by the second processor.

5. The radio terminal according to claim 1, wherein the updating module is configured to communicate with a remote management server and update the preconfigured radio parameter according to an instruction from the remote management server.

6. The radio terminal according to claim 5, wherein the updating module is configured to communicate with the remote management server via a network other than the PLMN.

7. The radio terminal according to claim 1, wherein the updating module is configured to:
acquire, via the protocol module, a first radio parameter sent from the PLMN for at least one of the PLMN-assisted discovery and the PLMN-assisted direct communication; and
update the preconfigured radio parameter based on the first radio parameter.

8. The radio terminal according to claim 1, wherein the updating module is configured to update the preconfigured radio parameter according to an instruction from a user via a user interface provided by the radio terminal.

9. The radio terminal according to claim 1, wherein the updating module is configured to update the preconfigured radio parameter based on one or both of time and place where the radio terminal performs at least one of the non-PLMN-assisted discovery and the non-PLMN-assisted direct communication.

10. The radio terminal according to claim 1, wherein a first radio resource specified by the preconfigured radio parameter is a subset of second radio resources specified by a master configuration managed by the radio terminal, a Universal Integrated Circuit Card (UICC), or a remote management server.

11. The radio terminal according to claim 10, wherein the updating module is configured to determine, out of the second radio resources, the first radio resource based on a magnitude of interference that the radio terminal is subjected to.

12. The radio terminal according to claim 10, wherein the updating module is configured to determine, out of the second radio resources, the first radio resource based on radio quality measured by the radio terminal.

13. The radio terminal according to claim 1, wherein the preconfigured radio parameter specifies at least one of a frequency band identifier, a frequency identifier, maximum transmission power, a Time Division Duplex (TDD) uplink-downlink configuration, and a resource block.

14. The radio terminal according to claim 1, wherein the updating of the preconfigured radio parameter includes one or both of deleting the preconfigured radio parameter and newly generating the preconfigured radio parameter.

15. The radio terminal according to claim 1, wherein the radio terminal is configured to disconnect or deactivate a connection to the PLMN, and perform at least one of the non-PLMN-assisted discovery and the non-PLMN-assisted direct communication.

16. The radio terminal according to claim 1, wherein the at least one processor includes a baseband processor and an application processor.

17. A Universal Integrated Circuit Card (UICC) configured to be coupled to a radio terminal, the UICC comprising:
a processor;
a memory area configured to store a preconfigured radio parameter used by the radio terminal to perform at least one of non-Public Land Mobile Network (PLMN)-assisted discovery and non-PLMN-assisted direct communication; and
a software module to be executed by the processor to update the preconfigured radio parameter stored in the memory area.

18. The UICC according to claim 17, wherein the software module is configured to communicate with a remote management server and update the preconfigured radio parameter according to an instruction from the remote management server.

19. The UICC according to claim 18, wherein the software module is configured to communicate with the remote management server via a network other than the PLMN.

20.-30. (canceled)

31. A method performed in a radio terminal, the method comprising:
updating a preconfigured radio parameter stored in a memory coupled to the radio terminal, wherein
the preconfigured radio parameter is used by the radio terminal to perform at least one of non-Public Land Mobile Network (PLMN)-assisted discovery and non-PLMN-assisted direct communication.

32.-39. (canceled)
